(19) United States
(12) Patent Application Publication
(10) Pub. No.: US 2022/0122153 A1
(43) Pub. Date: Apr. 21, 2022

(54) LEASE SUPPORTING APPARATUS

(71) Applicant: Toyota Jidosha Kabushiki Kaisha, Okazaki-shi Aichi-ken (JP)

(72) Inventor: Yoichi Onishi, Okazaki-shi Aichi-ken (JP)

(73) Assignee: Toyota Jidosha Kabushiki Kaisha, Toyota-shi Aichi-ken (JP)

(21) Appl. No.: 17/391,591

(22) Filed: Aug. 2, 2021

(30) Foreign Application Priority Data
Oct. 20, 2020 (JP) 2020-175770

(51) Int. Cl. G06Q 30/06; G06Q 30/02; G06Q 10/08

(52) U.S. Cl. CPC G06Q 30/0635; G06Q 10/083; G06Q 30/0206

(57) ABSTRACT

A lease supporting apparatus disclosed in the present specification includes a computer and a database. The computer accepts a selling price for the product that a purchaser intends to purchase. The computer calculates a total lease price using a difference between an acquisition price and the selling price of the product. The computer stores, in the database, the calculated total lease price in association with information of the product (product information). The computer presents, in response to a request from another computer, the product information and the total lease price that are registered in the database.

### CROSS-REFERENCE TO RELATED APPLICATION

This application claims priority to Japanese Patent Application No. 2020-175770 filed on Oct. 20, 2020, incorporated herein by reference in its entirety.

### BACKGROUND

### 1. Technical Field

A technology disclosed in the present specification relates to a lease supporting apparatus that creates a lease plan used for providing a lease before delivery of a product when there is a corresponding period until a delivery date of the product for which a sales contract is concluded.

### 2. Description of Related Art

A lease provider of a product sets a residual value of the product upon expiry of a lease period and determines a total lease price using a difference between an acquisition price and the residual value of the product. For example, a lease plan creation apparatus that generates a lease plan is disclosed in Japanese Unexamined Patent Application Publication No. 2003-67659. Technologies associated with a lease are also exemplified in Japanese Unexamined Patent Application Publication No. 2017-151655 and Japanese Unexamined Patent Application Publication No. 2001-283004.

### SUMMARY

When a lease plan is created, in a case where a residual value of a product at expiry of a lease period is not appropriately set, inconvenience arises. When the set residual value is too low, a total lease price becomes too high. When the set residual value is too high, there is a probability that the product may not be sold at the set residual value after the expiry of the lease period. In that case, it is inevitable that the product will be sold at a price lower than the set residual value, and the lease provider suffers a loss. The present specification provides a lease supporting apparatus capable of calculating an appropriate total lease price with respect to the price of the product after a lease ends.

A lease supporting apparatus disclosed in the present specification is an apparatus that creates a lease plan for a lease before delivery of a product for which a sales contract is concluded. The lease supporting apparatus includes a computer and a database. The computer accepts a selling price for the product that a purchaser intends to purchase. The computer calculates a total lease price using a difference between an acquisition price of the product and the selling price. The computer stores, in a database, the calculated total lease price in association with information of the product (product information). The computer presents, in response to a request from another computer, the product information and the total lease price registered in the database.

In the above aspect, the lease supporting apparatus creates the lease plan after the sales contract is concluded. Before the lease starts, the selling price of the product after the lease ends is fixed. The total lease price is determined using a difference between the selling price after the lease ends and the acquisition price of the product. The selling price after the lease ends corresponds to the residual value after the lease ends. Since the total lease price is calculated after the residual value after the lease ends (the selling price) is fixed, an appropriate total lease price with respect to the price of the product after the lease ends (the selling price) is calculated.

In the above aspect, the computer may accept a delivery date for the product that a purchaser intends to purchase, set a planned lease period to be shorter than a period from the present day to the delivery date, store, in the database, the planned lease period in association with the product information, and present, in response to a request from another computer, the product information, the total lease price, and the planned lease period that are stored in the database. In addition, the computer may calculate the lease fee for each unit period (for example, monthly) based on the total lease price and the planned lease period, store, in the database, the calculated lease fee and the planned lease period in association with information of the product (product information), and present, in response to the request from another computer, the product information, the lease fee, and the planned lease period that are registered in the database. It is also possible to present the lease fee for each unit period according to the planned lease period to another computer. Since the lease fee is calculated after the residual value after the lease ends (the selling price) is fixed, an appropriate lease fee with respect to the price of the product after the lease ends (the selling price) is calculated. The computer may set a plurality of planned lease periods and calculate the lease fee for each unit period with respect to the plurality of planned lease periods, respectively. It is possible to present lease fees for different lease periods to lease applicants.

In the above aspect, the computer may calculate the total lease price by adding overhead expenses required for starting use of the product to the difference. When the product is a vehicle, the overhead expenses include a registration cost, and the like. An appropriate lease fee including the overhead expenses is calculated.

In the above aspect, the computer may calculate the lease fee by multiplying the total lease price by a value in which a predetermined profit margin rate is added to 1.0, and dividing the multiplied total lease price by the planned lease period. The lease fee including an appropriate profit of the lease provider is calculated.

In the above aspect, the product may be an electric vehicle having a motor used for traveling and a battery that supplies power to the motor. Since calculating a price of a used electric vehicle is difficult, the vehicle is particularly appropriate as a target product of a lease supporting apparatus disclosed in the present specification. After the electric vehicle is delivered to a lessee, the computer of the lease supporting apparatus may repeatedly receive traveling information of the electric vehicle from the electric vehicle and store, in the database, the received traveling information in association with the product information. Alternatively, the computer of the lease supporting apparatus may repeatedly receive usage information of the battery mounted on the electric vehicle and store, in the database, the received usage information in association with the product information. When delivering the electric vehicle to the purchaser after the expiry of the lease period, it is possible to provide a use history of the electric vehicle or the battery to the purchaser.

Details and further improvements of technology disclosed in the present specification will be described in “DETAILED DESCRIPTION OF THE EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a lease supporting apparatus according to an embodiment and another computer connected to a computer of the lease supporting apparatus;

FIG. 2 is a flowchart of a process executed by the lease supporting apparatus; and

FIG. 3 is a flowchart of a process executed by the lease supporting apparatus (a simplified version).

### DETAILED DESCRIPTION OF EMBODIMENTS

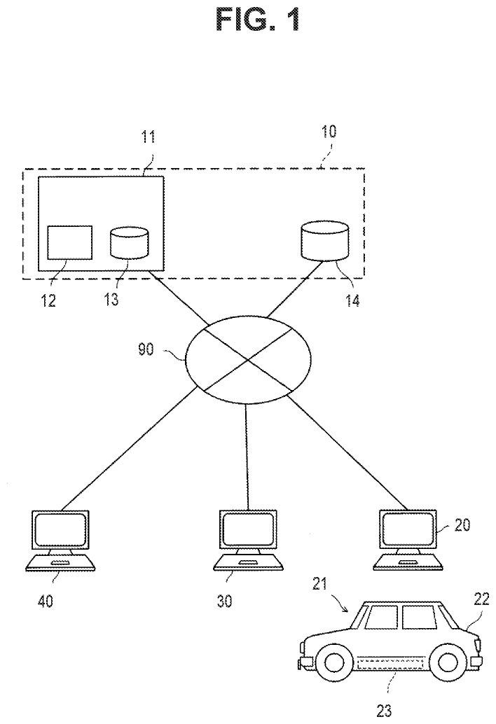

A lease supporting apparatus 10 according to an embodiment will be described with reference to drawings. FIG. 1 illustrates a block diagram of the lease supporting apparatus 10 and various computers connected to the lease supporting apparatus 10 via a network 90.

The lease supporting apparatus 10 is composed of a computer 11 and a database 14. The computer 11 and the database 14 are also communicably connected via the network 90. The lease supporting apparatus 10 is realized by a program implemented in the computer 11. The computer 11 includes a central processing unit (CPU) 12 and a memory 13. When the CPU 12 executes a lease support program stored in the memory 13, the computer 11 and the database 14 connected to the computer 11 function as the lease supporting apparatus 10.

An overview of the lease supporting apparatus 10 will be described. The lease supporting apparatus 10 supports selling and leasing of a product. The selling is premised on delivery of the product after a lease. That is, the lease supporting apparatus 10 supports the selling and leasing of a used product. The lease supporting apparatus 10 accepts a purchase price (a selling price for a lessor) and a delivery date of the product from a purchase applicant who desires to obtain the used product after a predetermined period (for example, several years later), and determines the planned lease period and the lease fee based on the selling price and the delivery date. Since the lease fee is determined after the selling price after the lease ends is determined, an appropriate lease fee is determined. By using the lease supporting apparatus 10, an appropriate lease fee with respect to the selling price after the lease ends is calculated.

Hereinafter, the lease supporting apparatus 10 will be described with the electric vehicle 21 as a target product. The lease supporting apparatus 10 is managed by the lessor. The lessor purchases the electric vehicle 21 from a new car dealer, leases the electric vehicle 21 for a predetermined period of time, and then sells it as a used vehicle. However, as described above, a sales contract for selling the electric vehicle 21 after the predetermined period is first concluded, and then the electric vehicle 21 is leased by setting the lease period within the predetermined period.

The lease supporting apparatus 10 is connected via the network 90 to a computer 20 of the seller of the electric vehicle 21, a computer 30 of the purchase applicant of a used electric vehicle 21, and a computer 40 of a lease applicant of the electric vehicle 21. Since there is a case where a plurality of purchase applicants or a plurality of lease applicants exists, there may be a plurality of each of computers 30 and 40. Here, to help understanding, it is assumed that the number of the computers 30 of the purchase applicant and the computers 40 of the lease applicant is one, respectively. An example of a purchase applicant may be a business operator that enables a plurality of registrants to share a vehicle (a car-sharing business operator).

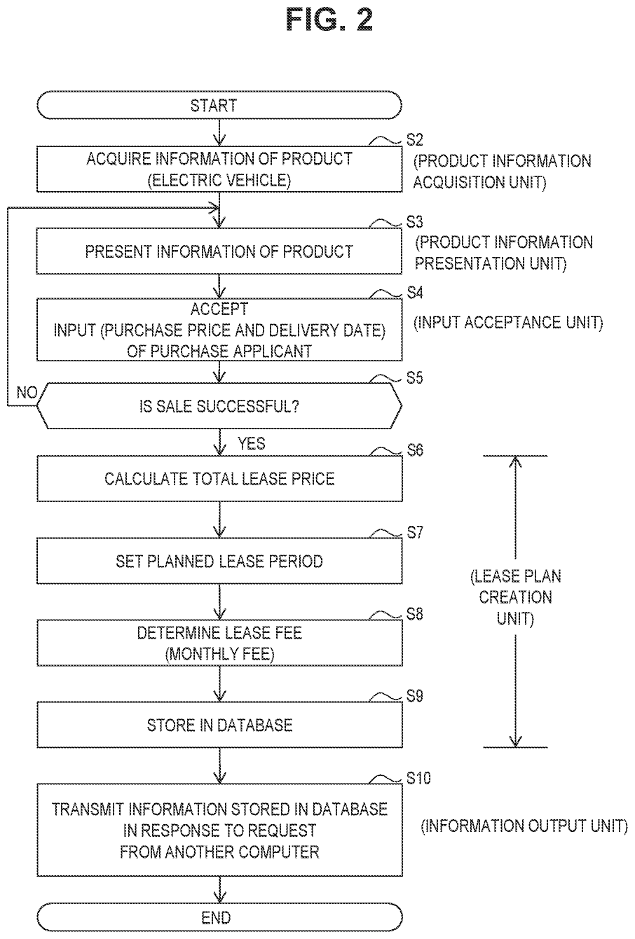

FIG. 2 illustrates a flowchart of a lease supporting process executed by the lease supporting apparatus 10. An operation of the lease supporting apparatus 10 will be described with reference to FIGS. 1 and 2. The product displayed in FIG. 2 is the electric vehicle 21. The information of the product described in steps S2 and S3 of FIG. 2 means vehicle information to be described below.

The lessor purchases the new electric vehicle 21 from the vehicle dealer. The computer 11 of the lease supporting apparatus 10 acquires the information of the electric vehicle 21 (vehicle information) from the computer 20 of the seller (step S2). At this time, the computer 11 of the lease supporting apparatus 10 functions as a product information acquisition unit. The vehicle information acquired by the computer 11 includes information, such as performance, color, an accessory, a planned delivery date, and a price (an acquisition price including a price of the accessory) of the electric vehicle 21. There is also a case where the accessory is designated by the purchase applicant at the time of the sales contract. The information of the accessory designated by the purchase applicant is not included in the vehicle information of step S2.

The vehicle information includes an identifier of a vehicle body 22 of the electric vehicle 21 (a vehicle body identifier) and an identifier of a mounted battery 23 (a battery identifier). The battery 23 supplies power to a motor used for traveling of the electric vehicle 21. The acquired vehicle information is stored in the database 14.

Subsequently, the computer 11 of the lease supporting apparatus 10 presents the vehicle information stored in the database 14 to the computer 30 of the purchase applicant via the network 90 (step S3). When executing step S3, the computer 11 functions as a product information presentation unit. As described above, there may be a plurality of purchase applicants (the computer 30 of the purchase applicant). The vehicle information is presented by a homepage created by the computer 11. Information of the vehicle body identifier, battery identifier, acquisition price, and vehicle body inspection certificate is not disclosed. Information not presented in step S3, from among the product information acquired in step S2, is determined in advance.

When the purchaser of the electric vehicle 21 is determined in advance, the computer 11 may separately transmit the vehicle information to the computer 30 of the purchase applicant instead of presenting it on the homepage.

A purchase applicant who desires to purchase the electric vehicle 21 operates his/her computer 30 and inputs a desired purchase price (a selling price for the lessor) and a desired delivery date. The computer 11 of the lease supporting apparatus 10 accepts the purchase price and the delivery date from the computer 30 of the purchase applicant (step S4). When executing step S4, the computer 11 functions as an input acceptance unit.

When the purchase applicant desires to add another accessory to the electric vehicle 21, the computer 11 accepts a name or model number of the accessory desired by the purchase applicant from the computer 30 of the purchase applicant before step S4. The computer 11 transmits the accepted name or model number to the computer 20 of the seller, acquires information of the accessory (performance, the price, and the like) from the computer 20, and updates the vehicle information stored in the database 14 by adding it to the previously acquired vehicle information. When the new information of the accessory is added, the acquisition price or selling price of the electric vehicle 21 is also updated.

When the sale of the electric vehicle 21 is not successful, the computer 11 presents the information of the product (the electric vehicle 21) (the vehicle information) to a computer of another purchase applicant (step S5: NO, S3).

After the sale is successful, the computer 11 calculates the total lease price using the difference between the acquisition price and the selling price of the electric vehicle 21 (step S6). Specifically, the computer 11 calculates, as the total lease price, a price obtained by adding overhead expenses required for starting the use of the electric vehicle 21 to the difference between the acquisition price and the selling price. The overhead expenses can include a registration cost, an initial maintenance cost, and the like, of the electric vehicle 21. The overhead expenses may be stored in the computer 11 in advance, or acquired by the computer 11 from the computer 20 of the seller (or another computer).

Next, the computer 11 sets a planned lease period to be shorter than a period from the present day to the delivery date (acquired in step S4) (step S7). There is also a case where the computer 11 sets a plurality of different planned lease periods. For example, when the period from the present day to the delivery date is 5 years, the computer 11 sets, as the planned lease periods, 3 years and 5 years corresponding to a timing of a legal vehicle body inspection.

Subsequently, the computer 11 calculates the lease fee per unit period based on the calculated total lease price (step S6) and the set planned lease period (step S7) (step S8). Specifically, the computer 11 calculates the lease fee by multiplying the total lease price (monthly fee) by a value obtained by adding a predetermined profit margin rate (for example, 0.03) to 1.0, and dividing the obtained value by the planned lease period (monthly).

The computer 11 stores, in the database 14, the calculated total lease price, the lease fee, and the set planned lease period in association with the vehicle information (step S9). When executing steps S6 to S9, the computer 11 functions as a lease plan creation unit.

In response to a request from another computer (the computer 40 of the lease applicant), the computer 11 presents the information stored in the database 14 (the vehicle information, the total lease price, the lease fee, and the planned lease period) (step S10). When executing step S10, the computer 11 functions as an information output unit.

The lease applicant browses the information output in step S10 (the vehicle information, the total lease price, the lease fee, and the planned lease period), and determines whether to apply for the lease. The lease applicant who determines to apply for the lease inputs information indicating that he/she desires the lease from his/her computer 40 to the computer 11 of the lease supporting apparatus 10. When the computer 11 of the lease supporting apparatus 10 accepts the input from the lease applicant (an input indicating that the lease is desired), a lease contract is concluded.

The computer 11 of the lease supporting apparatus 10 accepts an input of the delivery date and a delivery destination from the computer 40 of the lease applicant. The computer 11 transmits the delivery date and the delivery destination to the computer 20 of the seller of the electric vehicle 21. The seller delivers the electric vehicle 21 to the designated delivery destination on the designated delivery date.

The electric vehicle 21 includes a communication device mounted thereon and can communicate with the computer 11 of the lease supporting apparatus 10. During the lease period, the computer 11 periodically and repeatedly receives the traveling information of the electric vehicle 21 and the usage information of the battery 23, and stores, in the database 14, the information in association with the vehicle information.

The traveling information includes data on a traveling distance or acceleration/deceleration. The usage information of the battery 23 includes a remaining power amount immediately before charging, a charging amount, the number of times of charging, and the like. The traveling information and the usage information are presented to the purchase contractor when the electric vehicle 21 is delivered after the lease period expires.

As described above, the lease supporting apparatus 10 creates the lease plan after the sales contract is concluded. Before the lease starts, the selling price of the product after the lease ends is fixed. The total lease price is determined using the difference between the selling price after the lease ends and the acquisition price of the product. The selling price after the lease ends corresponds to the residual value after the lease ends. Since the lease fee is calculated after the residual value after the lease ends (the selling price) is fixed, an appropriate lease fee is calculated with respect to the price of the product after the lease (the selling price).

### MODIFIED EXAMPLE

A modified example of the lease supporting apparatus 10 will be described.

The computer of the lease supporting apparatus of the modified example executes a simpler process than that illustrated in the drawing. Hereinbelow, a computer of the lease supporting apparatus of the modified example will be referred to as a computer 11a in order to distinguish it from other computers.

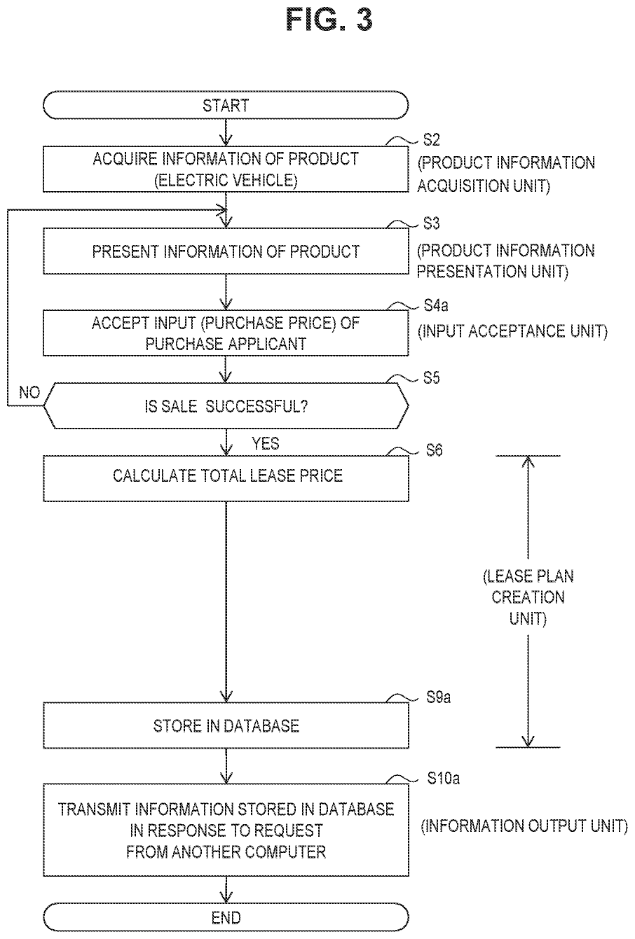

FIG. 3 illustrates a flowchart of a process executed by the computer 11a of the lease supporting apparatus of the modified example. Since the processes of steps S2 and S3 of FIG. 3 are the same as those of steps S2 and S3 of FIG. 2, the description thereof will be omitted.

The computer 11 of the embodiment accepts the selling price and the delivery date in step S4 (FIG. 2), but the computer 11a of the modified example accepts the purchase price (the selling price for the lessor) from the computer 30 of the purchase applicant (step S4a). In the same manner as in the embodiment, the selling price may include the price of the accessory of the electric vehicle 21.

When the sale of the electric vehicle 21 is not successful, the computer 11a presents the information of the product (the electric vehicle 21) (the vehicle information) to a computer of another purchase applicant (step S5: NO, S3).

After the sale is successful, the computer 11a calculates the total lease price using the difference between the acquisition price and the selling price of the electric vehicle 21 (step S6). A specific example of calculating the total lease price is the same as that of the computer 11 of the embodiment. The computer 11a of the modified example stores, in the database 14, the total lease price calculated in step S6 in association with the vehicle information without setting the planned lease period or determining the lease fee (step S9a). In response to a request from another computer (the computer 40 of the lease applicant), the computer 11a presents the information stored in the database 14 (the vehicle information and the total lease price) (step S10a). Other processes are the same as those of the computer 11 of the embodiment.

In the lease supporting apparatus of the modified example, since the process of the computer 11a is simpler than that of the computer 11 of the embodiment, load on the computer is reduced.

After step S4a, the computer 11a may set a planned lease period and store, in the database 14, a set planned seal period together with the total lease price.

The points to be noted associated with the technology described in the embodiment will be described. A target product of the lease supporting apparatus 10 is not limited to the electric vehicle, but can be any type of product. However, the processing for acquiring the traveling information and the usage information of the battery is limited to the electric vehicle.

The lease supporting apparatus 10 of the embodiment can be embodied in a computer program (a lease support program). The lease support program causes the computer 11 to function as the product information acquisition unit, the product information presentation unit, the input acceptance unit, the lease plan creation unit, and the output unit.

The product information acquisition unit acquires information on a product (product information) from the computer 20 of the seller of the product. The product information presentation unit provides the information to the computer 30 of the purchase applicant who desires to purchase the product. The input acceptance unit accepts an input, from the computer 30 of the purchase applicant, indicating the delivery date and the selling price for the product that the purchaser intends to purchase. The lease plan creation unit calculates the total lease price using the difference between the acquisition price and the selling price of the product, sets the planned lease period to be shorter than the period from the present day to the delivery date, calculates the lease fee for each unit period based on the total lease price and the planned lease period, and stores, in the database, the lease fee and the planned lease period in association with the product information. In response to a request from another computer (the computer 40 of the lease applicant), the output unit provides the computer 40 with the product information, the lease fee, and the planned lease period that are stored in the database 14.

As above, specific examples of the present disclosure have been described in detail, they are merely examples and do not limit the scope of the claims. The technology described in the claims includes variations and modifications of the specific examples exemplified above. The technical elements described in the present specification or in the drawings exhibit their technical usefulness alone or in various combinations, and are not limited to the combinations described in the scope of claims at the time of application. Further, the technology illustrated in the present specification or in the drawings can achieve a plurality of purposes at the same time, and achieving one of the purposes itself has technical usefulness.

What is claimed is:

1. A lease supporting apparatus that creates a lease plan for a lease before delivery of a product for which a sales contract is concluded, the lease supporting apparatus comprising:
a computer; and
a database,
wherein the computer is configured to:
accept a selling price for the product that a purchaser intends to purchase;
calculate a total lease price using a difference between an acquisition price of the product and the selling price;
store, in a database, the total lease price in association with product information of the product, and
present, in response to a request from another computer, the product information and the total lease price stored in the database.

2. The lease supporting apparatus according to claim 1, wherein the computer is configured to:
accept a delivery date for the product that the purchaser intends to purchase;
set a planned lease period to be shorter than a period from a present day to the delivery date;
store, in the database, the planned lease period in association with the product information, and
present, in response to the request, the product information, the total lease price, and the planned lease period that are stored in the database.

3. The lease supporting apparatus according to claim 2, wherein the computer is configured to:
calculate a lease fee for each unit period based on the total lease price and the planned lease period;
store, in the database, the lease fee in association with the product information; and
present, in response to the request, the product information, the total lease price, the planned lease period, and the lease fee that are stored in the database.

4. The lease supporting apparatus according to claim 3, wherein the computer is configured to:
set a plurality of planned lease periods; and
calculate the lease fee for each of the planned lease periods.

5. The lease supporting apparatus according to claim 3, wherein the computer is configured to calculate the lease fee by multiplying the total lease price by a value in which a predetermined profit margin rate is added to 1.0, and dividing the multiplied total lease price by the planned lease period.

6. The lease supporting apparatus according to claim 1, wherein the computer is configured to calculate the total lease price by adding overhead expenses required for starting use of the product to the difference.

7. The lease supporting apparatus according to claim 1, wherein:
the product is an electric vehicle having a motor used for traveling and a battery that supplies power to the motor; and
the computer is configured to, after the electric vehicle is delivered to a lessee, repeatedly receive traveling information of the electric vehicle from the electric vehicle, and store, in the database, the received traveling information in association with the product information.

8. The lease supporting apparatus according to claim 1, wherein:
the product is an electric vehicle having a motor used for traveling, and a battery that supplies power to the motor; and
the computer is configured to, after the electric vehicle is delivered to a lessee, repeatedly receive usage information of the battery and store, in the database, the received usage information in association with the product information.
